(19) United States
(12) Patent Application Publication
(10) Pub. No.: US 2014/0347561 A1
(43) Pub. Date: Nov. 27, 2014

(54) APPARATUS AND METHOD FOR VIDEO PROCESSING

(71) Applicants: Wei-Hsiang Shen, Taipei City (TW); Mi-Chien Lin, Taipei City (TW)

(72) Inventors: Wei-Hsiang Shen, Taipei City (TW); Mi-Chien Lin, Taipei City (TW)

(73) Assignee: COMPAL ELECTRONICS, INC., Taipei City (TW)

(21) Appl. No.: 14/243,909

(22) Filed: Apr. 3, 2014

Related U.S. Application Data
(60) Provisional application No. 61/827,742, filed on May 27, 2013.

(51) Int. Cl. H04N 5/58

(52) U.S. Cl. CPC H04N 5/58
USPC 348/602

(57) ABSTRACT

An apparatus and a method for video processing are provided. A first video signal is received by the apparatus for video processing. An impedance adjusting module analyses the first video signal, a control signal is generated by the impedance adjusting module according to a first gray level of the first video signal, and the impedance adjusting module adjusts an input impedance value according to the control signal. The first video signal is processed by the impedance adjusting module, and a second video signal is generated according to the input impedance value. The display module is coupled to the impedance adjusting module and receives the second video signal, wherein a second gray level of the second video signal is adjusted through the input impedance value.

### CROSS-REFERENCE TO RELATED APPLICATION

This application claims the priority benefits of U.S. provisional application Ser. No. 61/827,742, filed on May 27, 2013. The entirety of the above-mentioned patent applications is hereby incorporated by reference herein and made a part of this specification.

### BACKGROUND

1. Technical Field

The invention relates to a video processing technique. Particularly, the invention relates to an apparatus and a method for video processing, which is capable of adjusting an analog video signal according to a gray level of the analog video signal.

2. Related Art

Along with quick development of multimedia play technique, digital video becomes popular. However, many people still retain video output devices that only output analog videos, so that most of multimedia playing devices still provide interfaces of a variety of analog video specifications (for example, composite video baseband signal (CVBS), component video, etc.).

The analog video signal generally includes a luminance (brightness) signal and a chrominance signal, and a gray level of the analog video signal is changed along with the luminance signal. When an input voltage of the analog video signal becomes lower, the luminance corresponding to the analog video signal is also decreased. However, human eyes have a low recognition on low-luminance video images, so that it is necessary to provide a technique for ameliorating the low-luminance video image.

### SUMMARY

The invention is directed to an apparatus and a method for video processing, which is capable of improving a luminance of a low-gray level video image, and improving image characteristics such as contrast, resolution and saturation of the low-gray level video image.

The invention provides an apparatus for video processing including an impedance adjusting module and a display module. The apparatus for video processing is configured to receive a first video signal. The impedance adjusting module analyses the first video signal to generate a control signal according to a first gray level of the first video signal, and the impedance adjusting module adjusts an input impedance value according to the control signal, where a second video signal is generated through the first video signal according to the input impedance value. The display module is coupled to the impedance adjusting module, and the display module receives the second video signal, where a second gray level of the second video signal is adjusted through the input impedance value.

In an embodiment of the invention, the impedance adjusting module includes a signal controller and an impedance adjuster. The signal controller receives the first video signal, and analyses the first video signal to generate the control signal according to the first gray level of the first video signal. The impedance adjuster adjusts the input impedance value according to the control signal.

In an embodiment of the invention, the impedance adjuster includes a control signal distributor and a plurality of impedance adjusting modules. The control signal distributor receives the control signal, and generates a plurality of configuration control signals. The impedance adjusting modules respectively correspond to the configuration control signals, where each of the impedance adjusting modules includes an adjusting resistor and an adjusting transistor. The adjusting transistor is coupled to the adjusting resistor, and a control terminal of the adjusting transistor receives the corresponding configuration control signal, where an impedance value of the adjusting transistor is varied according to the corresponding configuration control signal.

In an embodiment of invention, the control signal distributor includes a plurality of distribution resistors. The distribution resistors are connected in series to each other, and divide the control signal into the configuration control signals through voltage division.

In an embodiment of the invention, the impedance adjusting module takes impedances of the impedance adjusting modules connected in parallel as the input impedance value.

In an embodiment of the invention, when the adjusting transistor is operated in a cut-off region according to the corresponding configuration control signal, the adjusting transistor is not turned on.

In an embodiment of the invention, when the adjusting transistor is operated in a linear region or a saturation region according to the corresponding configuration control signal, an impedance value of each of the impedance adjusting module is determined according to impedance values of the adjusting resistor and the adjusting transistor in the linear region, and the impedance adjusting modules are connected in parallel.

In an embodiment of the invention, the signal controller includes a buffer and clamp module, a signal conversion module and a direct current (DC) level buffer module. The buffer and clamp module buffers and clamps the first video signal. The signal conversion module obtains a clamed voltage of the first video signal, and converts the darned voltage of the first video signal into a DC level. The DC level buffer module buffers the DC level, and outputs the control signal according to the buffered DC level.

In an embodiment of the invention, when impedance values of the impedance adjusting modules of the impedance adjuster and an input resistance of the display module are connected in parallel, an output impedance is 75 ohms.

According to another aspect, the invention provides a method for video processing, which includes following steps. A first video signal is received. The first video signal is analysed, and a control signal is generated according to a first gray level of the first video signal, and an input impedance value is adjusted according to the control signal, where a second video signal is generated through the first video signal according to the input impedance value. The second video signal is received, wherein a second gray level of the second video signal is adjusted through the input impedance value.

In an embodiment of the invention, the step of analysing the first video signal to generate the control signal according to the first gray level of the first video signal and adjusting the input impedance value according to the control signal includes following steps. The first video signal is received, and the first video signal is analysed to generate the control signal according to the first gray level of the first video signal. The input impedance value is adjusted according to the control signal.

In an embodiment of the invention, the step of adjusting the input impedance according to the control signal includes following steps. The control signal is received, and configuration control signals are generated. The configuration control signals are respectively received, where an impedance value of one of a plurality of impedance adjusting modules is varied according to the corresponding configuration control signal.

In an embodiment of invention, the step of receiving the control signal and generating the configuration control signal includes following steps. The control signal is voltage-divided to generate the configuration control signals.

In an embodiment of the invention, the step of adjusting the input impedance value according to the control signal includes a following step. Impedance values of the impedance adjusting modules connected in parallel are taken as the input impedance value.

In an embodiment of the invention, the step of adjusting the input impedance value according to the control signal includes a following step. When an adjusting transistor of one of the impedance adjusting modules is operated in a cut-off region according to each of the configuration control signals, the adjusting transistor is not turned on.

In an embodiment of the invention, the step of adjusting the input impedance value according to the control signal includes a following step. When the adjusting transistor of one of the impedance adjusting modules is operated in a linear region or a saturation region according to each of the configuration control signals, an impedance of the corresponding adjusting transistor is varied according to each of the configuration control signals.

In an embodiment of the invention, the step of receiving the first video signal, analysing the first video signal and generating the control signal according to the first gray level of the first video signal includes following steps. The first video signal is buffered and clamped. A clamed voltage of the first video signal is obtained, and the darned voltage of the first video signal is converted into a DC level. Moreover, the DC level is buffered, and the control signal is output according to the buffered DC level.

In an embodiment of the invention, an output impedance obtained by connecting impedance values of the impedance adjusting modules of the impedance adjuster and an input resistance of the display module in parallel is 75 ohms.

According to the above descriptions, in the apparatus and method for video processing of the invention, the impedance adjusting module analyses the received first video signal, and the input impedance value is adjusted according to the gray level of the first video signal, so as to generate the second video signal, where the gray level of the second video signal is adjusted according to the input impedance value. In this way, the apparatus for video processing of the invention can increase the luminance of the low-gray level video image, so as to improve image characteristics such as resolution, contrast, saturation, etc.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus for video processing according to an embodiment of the invention.

FIG. 2 is a flowchart illustrating a method for video processing according to an embodiment of the invention.

FIG. 3 is a block diagram of an impedance adjusting module according to an embodiment of the invention.

FIG. 4 is an example of a relationship between a drain current and a drain to source voltage of an adjusting transistor according to an embodiment of the invention.

FIG. 5 is an example of an impedance adjuster according to an embodiment of the invention.

FIG. 6A and FIG. 6B are schematic diagrams illustrating relationships between gray levels and DC levels of a video signal according to an embodiment of the invention.

### DETAILED DESCRIPTION OF DISCLOSED EMBODIMENTS

In order to improve image characteristics of a low-gray level video signal, embodiments of the invention provide an apparatus and a method for video processing. The apparatus for video processing receives an analog video signal such as a composite video baseband signal (CVBS), a component video signal, etc., and an impedance adjusting module analyses the received video signal, and adjusts an impedance value of the impedance adjusting module according to a gray level of the received video signal, so that an input impedance value of the apparatus for video processing is changed to generate a video signal with a gray level different to the gray level of the received video signal. In this way, a luminance of the low-gray level video image played by a multimedia playing device is increased, and even a contrast, a resolution and a saturation of the low-gray level video image are increased.

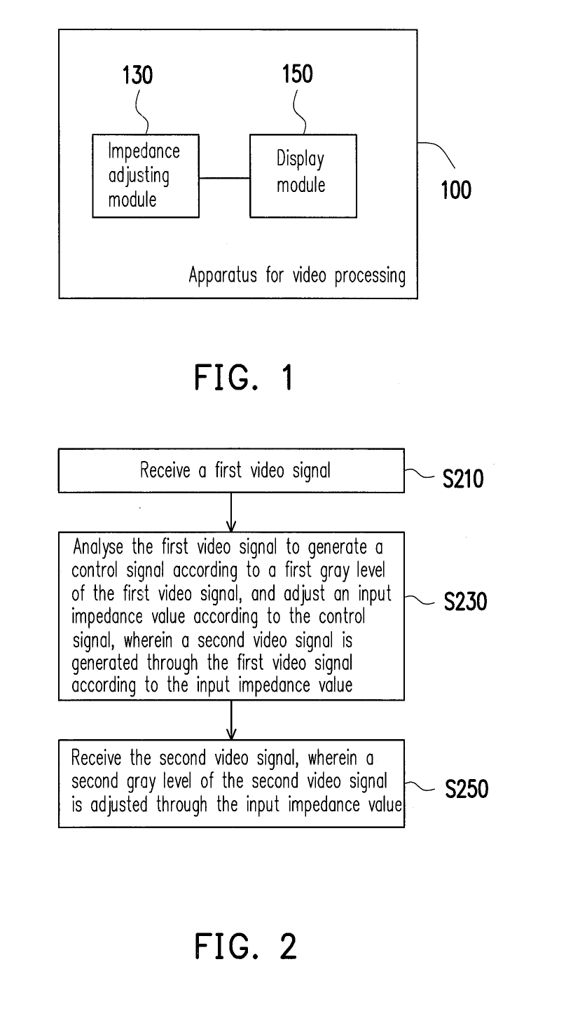

FIG. 1 is a block diagram of an apparatus for video processing according to an embodiment of the invention. Referring to FIG. 1, the apparatus for video processing 100 includes an impedance adjusting module 130 and a display module 150.

The video processing device 100 receives a first video signal V₁ output by a multimedia device adapted to output analog signals such as a digital versatile disk (DVD) player, a video compact disk (VCD) player, a video game machine, etc. The first video signal V₁ can be an analog video signal such as a composite video baseband signal (CVBS), a component video signal, etc. The first video signal V₁ may include a luminance (which is also referred to as brightness) signal and a chrominance signal.

Generally, when a characteristic impedance of the apparatus for video processing 100 is 75 ohms, the analog video signal (for example, the CVBS, the component video signal) is matched to a ground impedance with the input impedance value of 75 ohms, such that a voltage level of 1 vpp (voltage peak-to-peak) (for the CVBS) or 0.7 vpp (for the component video signal) of the analog video signal is generated through the input impedance value of 75 ohms. Since the input impedance value is maintained unchanged, a gray level (i.e. luminance) of the analog video signal is linearly varied along with a voltage value of the input video signal (i.e. the lower the voltage value is, the lower the corresponding gray level (i.e. luminance) is). For example, in the present embodiment, the gray levels are quantified into 255 levels, i.e. the gray level of 0 is completely black, and the gray level of 255 is completely white. In this way, when the input voltage of the video signal is 0-0.2 volts, a gray level corresponding to an output image of an analog-to-digital converter (ADC) is 0-73 level.

However, most of the display devices (for example, a liquid crystal display (LCD), an organic electro-luminescent display (OLED), etc.) do not necessarily ensure people to get a good visual experience when viewing a low-luminance video image (for example, the resolution, contrast or saturation of the low-luminance image are lower). Therefore, in order to improve the image characteristics of the low-luminance video signal, in the present embodiment, the input impedance value can be adjusted according to the gray level of the video signal, such that the luminance (i.e. gray level) of the low-gray level video signal can be increased, so as to increase the resolution, contrast or saturation of the low-gray level video image.

Referring to FIG. 1, the impedance adjusting module 130 adjusts an input impedance value Z according to the first video signal V₁ received by the apparatus for video processing 100. The display module 150 can be an LCD, an OELD, etc. The display module 150 is coupled to the impedance adjusting module 130, and is configured to receive a second video signal V₂ generated according to the input impedance value Z adjusted by the impedance adjusting module 130 according to the first video signal V_{I}, so as to display an image. In the present embodiment of the invention, the input impedance value of the display module 140 is 150 ohms.

FIG. 2 is a flowchart illustrating a method for video processing according to an embodiment of the invention. Referring to FIG. 2, the method for video processing of the present embodiment is adapted to the apparatus for video processing 100 of FIG. 1, and the method of the present embodiment is described in detail below with reference of various components of the apparatus for video processing 100. The flow of the method can be adjusted according to an application requirement, and is not limited to the flow described below.

In step S201, the apparatus for video processing 100 receives the first video signal V₁. For example, the user connects the CVBS to the apparatus for video processing 100 by plugging a radio corporation of America (RCA) terminal (for example, yellow) into a RCA jack of the apparatus for video processing 100. The user connects a Y signal of the component video to the apparatus for video processing 100 by plugging the RCA terminal (for example, green) into the RCA jack of the apparatus for video processing 100.

In step S230, the impedance adjusting module 130 analyses the first video signal V₁, and generates a control signal C according to a first gray level of the first video signal V₁, and the impedance adjusting module 130 adjusts the input impedance value Z according to the control signal C, where the second video signal V₂ is generated through the first video signal. V₁ according to the input impedance value Z.

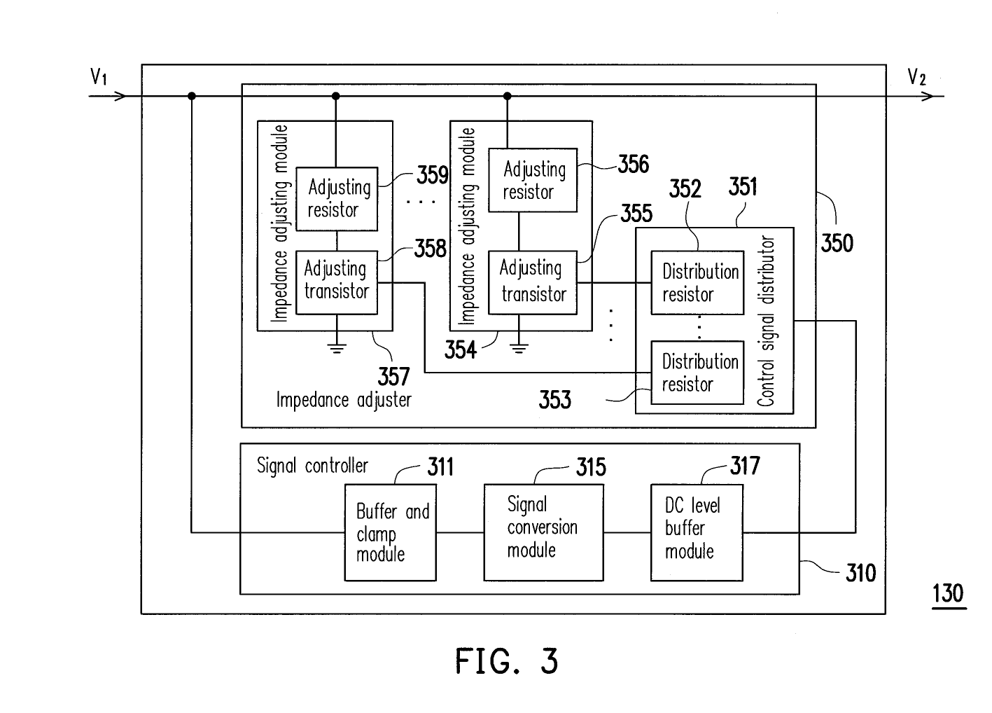

In detail, FIG. 3 is a block diagram of the impedance adjusting module 130 according to an embodiment of the invention. Referring to FIG. 1, FIG. 2 and FIG. 3, the impedance adjusting module 130 includes a signal controller 310 and an impedance adjuster 350. The signal controller 310 receives the first video signal V₁, and analyses the first video signal V₁ to generate a control signal C_{S} according to the first gray level of the first video signal V₁. The impedance adjuster 350 adjusts the input impedance value Z according to the control signal C_{S}.

It should be noticed that in the present embodiment, the signal controller 310 includes a buffer and clamp module 311, a signal conversion module 315 and a direct current (DC) level buffer module 317. The buffer and clamp module 311 buffers and clamps the first video signal V_{I}, for example, amplifies a voltage of the first video signal V₁ by six times through an amplifier, and compares through a clamping technique to select a required waveform. The signal conversion module 315 obtains a clamed voltage of the first video signal V_{I}, and converts the darned voltage of the first video signal V₁ into a DC level, for example, the required DC level is adjusted by two transistors. Moreover, the DC level buffer module 317 buffers the DC level to output the control signal C_{S}, for example, amplifies the DC level by three times through an amplifier to form the control signal C_{S}.

Moreover, the impedance adjuster 350 includes a control signal distributor 351 and impedance adjusting modules 354 and 357. In the present embodiment, the impedance adjustor 350 includes M impedance adjustor modules, where M is a positive integer. The number of the impedance adjusting modules is not limited by the invention, and in other embodiments, the impedance adjuster 350 may have 3, 5 or 6 impedance adjusting modules. The control signal distributor 351 receives the control signal C_{S} and generates M configuration control signals. The control signal distributor 351 includes distribution resistors 352 and 353, and in the present embodiment, the control signal distributor 351 includes M distribution resistors. The number of the distribution resistors is not limited by the invention, and in other embodiments, the control signal distributor 351 may have 3, 5 or 6 distribution resistors, and the number of the distribution resistors and the number of the impedance adjusting modules are the same. The distribution resistors 352 and 353 are connected in series to each other to divide the control signal C_{S} into the M configuration control signals through voltage division.

The impedance adjusting modules 354 and 357 respectively correspond to the M configuration control signals, and in the present embodiment, the impedance adjusting modules 354 and 357 respectively include adjusting resistor 356, 359 and adjusting transistors 355 and 358. The adjusting transistors 355 and 358 are respectively coupled to the corresponding adjusting resistors 356 and 359, and control terminals of the adjusting transistors 355 and 358 receives the corresponding M configuration control signals, where impedance values of the adjusting transistor 355 and 358 are varied according to the corresponding M configuration control signals.

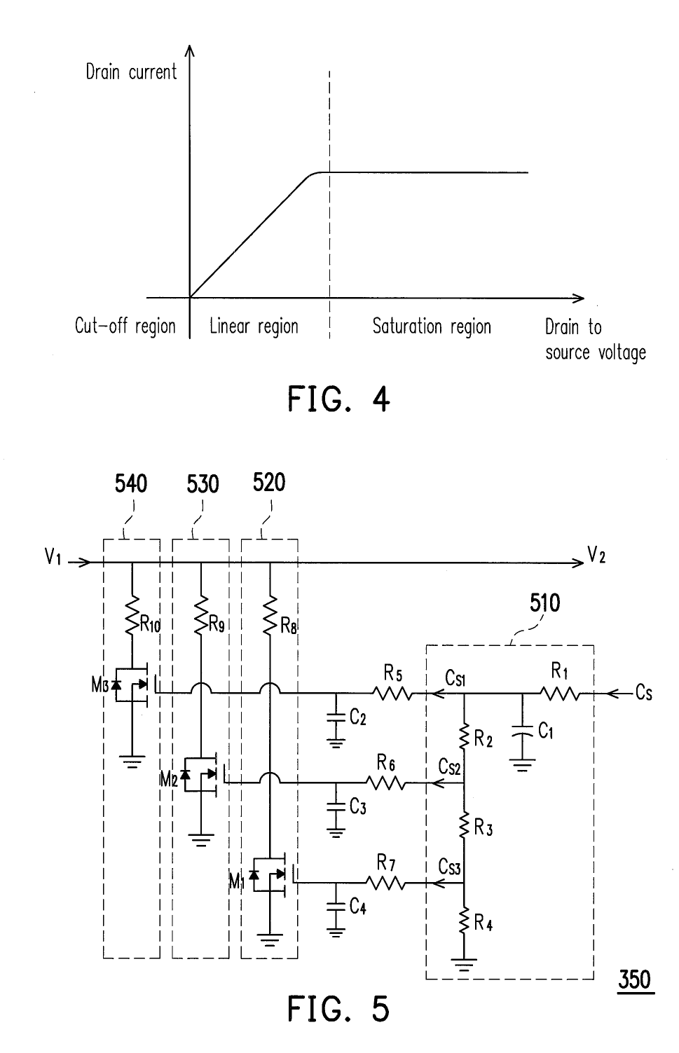

In detail, FIG. 4 is an example of a relationship between a drain current and a drain to source voltage of the adjusting transistor according to an embodiment of the invention. Referring to FIG. 3 and FIG. 4, taking the adjusting transistor 355 as an example, when the adjusting transistor 355 is operated in a cut-off region according to the corresponding configuration control signal (for example, CS1), the adjusting transistor 355 is not turned on. In FIG. 4, when a voltage V_{GS} between a gate and a source (G represent the gate, and S represents the source) is smaller than a threshold voltage Vₜₕ, the adjusting transistor 355 is in a turn-off state, and a current cannot flow through the adjusting transistor 355, i.e. the adjusting transistor 355 is not turned on.

When the adjusting transistor 355 is operated in a linear region (which is also referred to as a triode region) or a saturation region according to the corresponding configuration control signal, the impedance value of the impedance adjusting module 354 is determined according to impedance values of the adjusting resistor 356 and the adjusting transistor 355 in the linear region. The impedance value of the adjusting transistor 355 in the linear region is 1/(μₙCₒₓ(W/L)(V_{GS}−Vₜₕ)), where μₙ is carrier mobility, W is a gate width of the adjusting transistor 355, L is a gate length of the adjusting transistor, and Cₒₓ is a unit capacitance of a gate oxide layer of the adjusting transistor 355. Descriptions of the other impedance adjusting modules, adjusting transistors and adjusting resistors can be deduced by referring to related descriptions of the impedance adjusting module 354, the adjusting transistor 355 and the adjusting resistor 356, which are not repeated. In the present embodiment, the impedance adjusting modules 354 and 357 are connected in parallel to each other, and the impedance adjusting module 130 takes impedance of the impedance adjusting modules connected in parallel as the input impedance value Z.

For example, FIG. 5 is an example of the impedance adjuster 350 according to an embodiment of the invention. Referring to FIG. 5, a control signal distributor 510 includes distribution resistors R₂, R₃ and R₄, the control signal C is divided into configuration control signals C_{S1}, C_{S2} and C_{S3} by the distribution resistors R₂, R₃ and R₄ connected in series. The configuration control signals C_{S1}, C_{S2} and C_{S3} are respectively coupled to ground capacitors C₂, C₃ and C₄, and are respectively input to impedance adjusting modules 520, 530 and 540. The impedance adjusting modules 520, 530 and 540 respectively include adjusting transistors M₁, M₂ and M₃ and adjusting resistors R₈, R₉ and R₁₀. The adjusting transistors M₁, M₂ and M₃ respectively adjust the impedance values of the impedance adjusting modules 520, 530 and 540 according to the configuration control signals C_{S1}, C_{S2} and C_{S3}.

In an embodiment, a resistance of the adjusting resistor R₈ is 510 ohm, a resistance of the adjusting resistor R₉ is 1100 ohm, and a resistance of the adjusting resistor R₁₀ is 260 ohm. In order to increase the luminance of the low-gray level video signal, the low-gray level video signal is adjusted to have higher input impedance value. For example, when the first gray level of the received video signal is 50 (total 255 levels), the control signal C_{S} generated by the signal controller 310 of FIG. 3 is larger, and the adjusting transistors M₁, M₂ and M₃ are not turned on (i.e. operated in the cut-off region) under control of the configuration control signals C_{S1}, C_{S2} and C_{S3}. Now, the input impedance value formed by the impedances of the impedance adjusting modules 520, 530 and 540 connected in parallel is the maximum, and the second gray level of the second video signal V₂ generated according to the input impedance Z is accordingly increased.

When the first gray level of the received video signal is 80 (total 255 levels), the adjusting transistors M₁ and M₂ are not turned on (i.e. operated in the cut-off region) under control of the configuration control signals C_{S1}, C_{S2} and C_{S3}. Now, the input impedance value is the impedance values of the impedance adjusting modules 520 and 530 connected in parallel. When the first gray level of the received video signal is 100 (total 255 levels), the adjusting transistor M₁ is not turned on (i.e. operated in the cut-off region) under control of the configuration control signals C_{S1}, C_{S2} and C_{S3}. Now, the input impedance value is the impedance value of the impedance adjusting module 520.

Moreover, when the first gray level of the received video signal is 120 (total 255 levels), the adjusting transistors M₁, M₂ and M₃ are all turned on (i.e. operated in the saturation region) under control of the configuration control signals C_{S1}, C_{S2} and C_{S3}. Now, the input impedance value Z formed by the impedances of the impedance adjusting modules 520, 530 and 540 connected in parallel is 150 ohms. When the input impedance value of the display module 150 of FIG. 1 is 150 ohms, and the input impedance value of the impedance adjusting modules 520, 530 and 540 connected in parallel is connected in parallel with an input resistance of the display module 150, the output impedance is 75 ohms. Namely, the first gray level of the video signal is not adjusted. In the present embodiment, the input impedance value Z can be adjusted to 75 to 150 ohms according to the control signal C_{S}.

It should be noticed that in other embodiments, the impedance adjusting modules can also be variable resistors or digital potentiometers. However, the present embodiment of the invention is not limited to the type of the impedance adjusting module, and any impedance adjusting module that can be adjusted to the required the impedance value according to the configuration control signals C_{S1}-C_{SM} is adapted to be used as the impedance adjusting module of the present embodiment.

Referring to FIG. 1, FIG. 2 and FIG. 3, in step S250, the display module 150 receives the second video signal V₂, where the second gray level of the second video signal V₂ is adjusted through the input impedance value Z. In detail, since the control signal C_{S} is varied along with the second gray level of the second video signal V₂, the input impedance value Z is also varied along with the control signal C_{S}. A variation time of the input impedance value Z is, for example, 1.5 second. If the input impedance value Z adjusted by the impedance adjusting module 130 is different to 75 ohms, the second gray level of the second video signal V₂ generated by the impedance adjusting module 130 according to the first video signal V₁ is also varied along with the input impedance value Z.

In this way, the luminance of the low-gray level video signal is increased. For example, when the apparatus for video processing 100 of the invention is not applied, the voltage of the input video signal is 0-0.2 volts, and the gray level corresponding to the output of the ADC is 0-73 (total 255 levels). When the apparatus for video processing 100 of the invention is applied, the voltage of the video signal is increased to 0-0.26 volts, and the gray level corresponding to the output of the ADC is 0-94 (total 255 levels), so that 21 levels of the gray level is increased (increased about 30%) compared to the situation without applying the apparatus for video processing 100 of the invention.

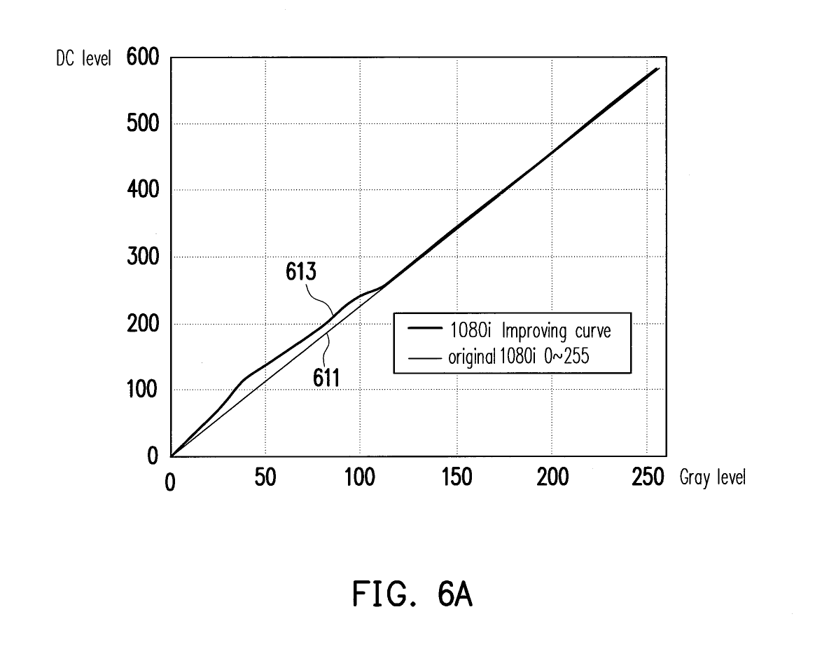

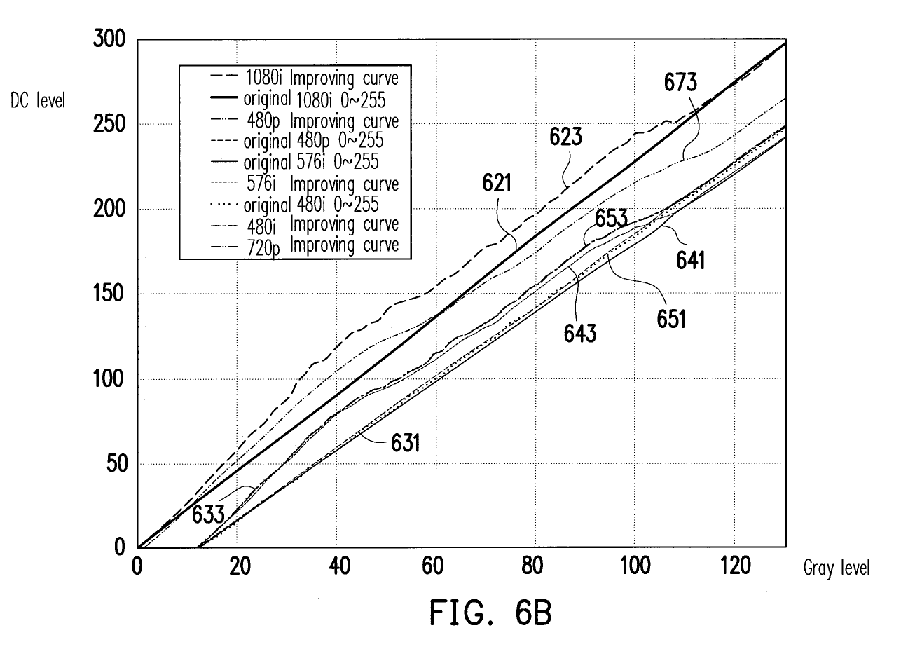

FIG. 6A and FIG. 6B are schematic diagrams illustrating relationships between gray levels and DC levels of a video signal according to an embodiment of the invention. Referring to FIG. 6A, when the input video signal has a 1080i signal format, within a range of the gray value of about 0-120, a DC level of an improving curve 613 is higher than that of an original curve 611. When the DC level is increased, the luminance (i.e. the gray level) of the video signal is also increased.

It should be noticed that the apparatus for video processing of the present embodiment is adapted to process video signals of various signal formats. Referring to FIG. 6B, DC levels of improving curves 623, 633, 643, 653 and 673 of different signal formats (for example, 480i, 480p, 576i, 720p and 1080i) are higher than that of the corresponding original curves 621, 631, 641 and 651.

Moreover, besides that the apparatus for video processing of the invention is capable of increasing the gray level (i.e. the luminance) of the low-gray level video signal, the apparatus for video processing of the invention is also capable of ameliorating a gamma curve or a dynamic contrast between a black part and gray part of a video image. Therefore, the apparatus for video processing of the invention can also improve image characteristics of contrast, resolution, saturation, etc.

It should be noticed that in the aforementioned embodiment, by adjusting the input impedance value Z to 75-150 ohms, the luminance of the low-gray level video signal may have a better response. Moreover, based on user's experience, the input impedance value Z can be adjusted to exceed 150 ohms, for example, an adjusting range of the input impedance value Z is 75-200 ohms.

In summary, according to the apparatus and method for video processing of the invention, the apparatus for video processing receives a video signal, and the impedance adjusting module adjusts the input impedance value according to the gray level of the video signal to generate a video signal with a different gray level, and the display module receives the video signal with varied gray level to display an image. In this way, the apparatus for video processing of the invention can increase the luminance of the low-gray level video image, so as to improve image characteristics such as resolution, contrast, saturation, etc.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An apparatus for video processing, configured to receive a first video signal, and comprising:
an impedance adjusting module, analysing the first video signal to generate a control signal according to a first gray level of the first video signal, and adjusts an input impedance value according to the control signal, wherein a second video signal is generated through the first video signal according to the input impedance value; and
a display module, coupled to the impedance adjusting module, and configured to receive the second video signal,
wherein a second gray level of the second video signal is adjusted through the input impedance value.

2. The apparatus for video processing as claimed in claim 1, wherein the impedance adjusting module comprises:
a signal controller, receiving the first video signal, and analysing the first video signal to generate the control signal according to the first gray level of the first video signal; and
an impedance adjuster, adjusting the input impedance value according to the control signal.

3. The apparatus for video processing as claimed in claim 2, wherein the impedance adjuster comprises:
a control signal distributor, receiving the control signal, and generating a plurality of configuration control signals;
a plurality of impedance adjusting modules, respectively corresponding to the configuration control signals, wherein each of the impedance adjusting modules comprises:
an adjusting resistor; and
an adjusting transistor, coupled to the adjusting resistor, and a control terminal of the adjusting transistor receiving the corresponding one of the configuration control signals, wherein an impedance value of the adjusting transistor is varied according to the corresponding one of the configuration control signals.

4. The apparatus for video processing as claimed in claim 3, wherein the control signal distributor comprises:
a plurality of distribution resistors, connected in series to each other, and dividing the control signal into the configuration control signals through voltage division.

5. The apparatus for video processing as claimed in claim 3, wherein the impedance adjusting module takes impedances of the impedance adjusting modules connected in parallel as the input impedance value.

6. The apparatus for video processing as claimed in claim 3, wherein when the adjusting transistor is operated in a cut-off region according to the corresponding one of the configuration control signals, the adjusting transistor is not turned on.

7. The apparatus for video processing as claimed in claim 3, wherein when the adjusting transistor is operated in a linear region or a saturation region according to the corresponding one of the configuration control signals, an impedance value of each of the impedance adjusting module is determined according to impedance values of the adjusting resistor and the adjusting transistor in the linear region, and the impedance adjusting modules are connected in parallel.

8. The apparatus for video processing as claimed in claim 2, wherein the signal controller comprises:
a buffer and clamp module, buffering and clamping the first video signal;
a signal conversion module, obtaining a clamed voltage of the first video signal, and converting the clamed voltage of the first video signal into a direct current (DC) level; and
a DC level buffer module, buffering the DC level to output the control signal.

9. The apparatus for video processing as claimed in claim 3, wherein when impedance values of the impedance adjusting modules of the impedance adjuster and an input resistance of the display module are connected in parallel, an output impedance is 75 ohms.

10. A method for video processing, comprising:
receiving a first video signal;
analysing the first video signal to generate a control signal according to a first gray level of the first video signal, and adjusting an input impedance value according to the control signal, wherein a second video signal is generated through the first video signal according to the input impedance value; and
receiving the second video signal, wherein a second gray level of the second video signal is adjusted through the input impedance value.

11. The method for video processing as claimed in claim 10, wherein the step of analysing the first video signal to generate the control signal according to the first gray level of the first video signal and adjusting the input impedance value according to the control signal comprises:
receiving the first video signal, and analysing the first video signal to generate the control signal according to the first gray level of the first video signal; and
adjusting the input impedance value according to the control signal.

12. The method for video processing as claimed in claim 11, wherein the step of adjusting the input impedance according to the control signal comprises:
receiving the control signal, and generating a plurality of configuration control signals;
respectively receiving the configuration control signals, wherein an impedance value of one of a plurality of impedance adjusting modules is varied according to the corresponding configuration control signal.

13. The method for video processing as claimed in claim 12, wherein the step of receiving the control signal and generating the configuration control signal comprises:
voltage-dividing the control signal to generate the configuration control signals.

14. The method for video processing as claimed in claim 12, wherein the step of adjusting the input impedance value according to the control signal comprises:
taking impedance values of the impedance adjusting modules connected in parallel as the input impedance value.

15. The method for video processing as claimed in claim 12, wherein the step of adjusting the input impedance value according to the control signal comprises:
when an adjusting transistor of one of the impedance adjusting modules is operated in a cut-off region according to each of the configuration control signals, not to turn on the adjusting transistor.

16. The method for video processing as claimed in claim 12, wherein the step of adjusting the input impedance value according to the control signal comprises:
when an adjusting transistor of one of the impedance adjusting modules is operated in a linear region or a saturation region according to each of the configuration control signals, varying an impedance of the corresponding adjusting transistor according to each of the configuration control signals.

17. The method for video processing as claimed in claim 11, wherein the step of receiving the first video signal, analysing the first video signal and generating the control signal according to the first gray level of the first video signal comprises:
buffering and clamping the first video signal;
obtaining a clamed voltage of the first video signal, and converting the voltage of the first video signal into a DC level; and
buffering the DC level to output the control signal.

18. The method for video processing as claimed in claim 10, wherein an output impedance obtained by connecting impedance values of the impedance adjusting modules of the impedance adjuster and an input resistance of the display module in parallel is 75 ohms.
